(19) United States
(12) Patent Application Publication
(10) Pub. No.: US 2026/0063524 A1
(43) Pub. Date: Mar. 5, 2026

(54) Tensile Testing Apparatus

(71) Applicant: Product Innovation and Engineering, LLC, St. James, MO (US)

(72) Inventors: Connor Lane COWARD, Arvada, CO (US); Sriram Praneeth ISANAKA, Rolla, MO (US)

(21) Appl. No.: 19/376,346

(22) Filed: Oct. 31, 2025

Related U.S. Application Data
(63) Continuation-in-part of application No. 17/901,037, filed on Sep. 1, 2022, now Pat. No. 12,460,999.
(60) Provisional application No. 63/242,094, filed on Sep. 9, 2021.

(51) Int. Cl. G01N 3/04; G01N 3/08

(52) U.S. Cl. CPC G01N 3/04; G01N 3/08; G01N 2203/0017; G01N 2203/006; G01N 2203/0206; G01N 2203/0252; G01N 2203/0447; G01N 2203/047; G01N 2203/0647

(57) ABSTRACT

A tensile testing apparatus includes a specimen cartridge and a jaw actuator. The jaw actuator is operable to grip and pull a specimen in tension. The specimen cartridge is operable for holding multiple specimens. The specimen cartridge is rotatable for sequentially presenting specimens to the jaw actuator.

### CROSS-REFERENCE TO RELATED APPLICATIONS

This application is a continuation-in-part of U.S. patent application Ser. No. 17/901,037 filed Sep. 1, 2022, which published as US2023/0075936 on Mar. 9, 2023 and issues as U.S. Pat. No. 12,460,999 on Nov. 4, 2025. U.S. patent application Ser. No. 17/901,037 claims priority to and the benefit of U.S. Provisional Ser. No. 63/242,094 filed Sep. 9, 2021. The entire disclosures of the above patents and patent applications are incorporated herein by reference.

### FIELD

The present disclosure relates generally to a tensile testing apparatus.

### BACKGROUND

This section provides background information related to the present disclosure which is not necessarily prior art.

This disclosure pertains to a tensile testing apparatus. More specifically, this disclosure pertains to an autonomous, miniature specimen tensile testing apparatus that is designed to sequentially test multiple miniature specimens of a material or of various materials by applying a tension force to a specimen of the material and observe and record the deformation and reaction of the specimen to the tensile test.

### DRAWINGS

The drawings described herein are for illustrative purposes only of selected embodiments and not all possible implementations and are not intended to limit the scope of the present disclosure.

FIG. 1 is a representation of a perspective view of the tensile testing apparatus of this disclosure from one side of the apparatus.

FIG. 2 is a representation of a perspective view of the apparatus from a second, opposite side of the apparatus from that represented in FIG. 1.

FIG. 3 is a representation of a side elevation view of the apparatus of FIG. 1.

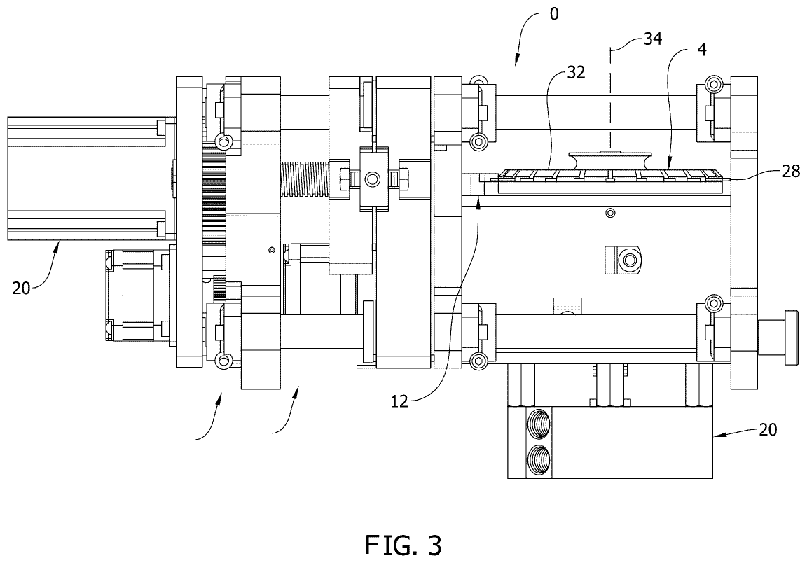

FIG. 4 is a representation of a side elevation view of the apparatus of FIG. 2.

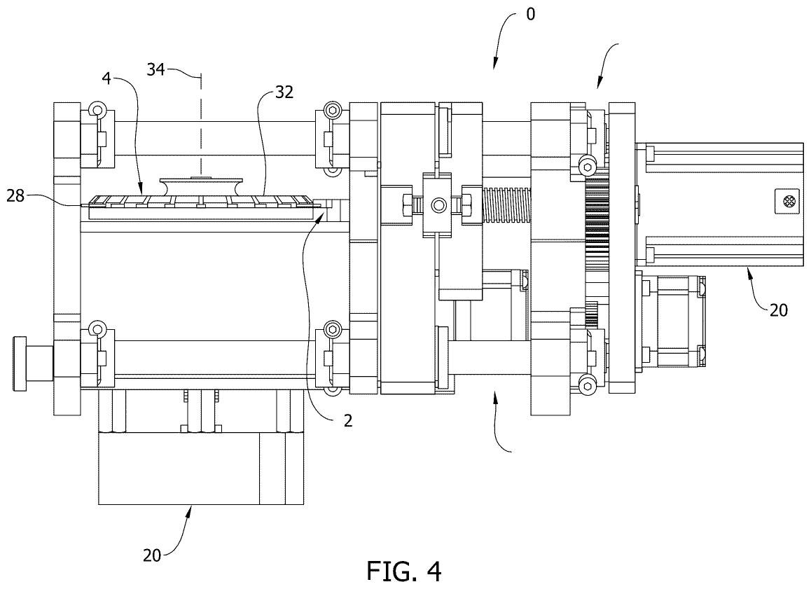

FIG. 5 is a representation of a top plan view of the apparatus.

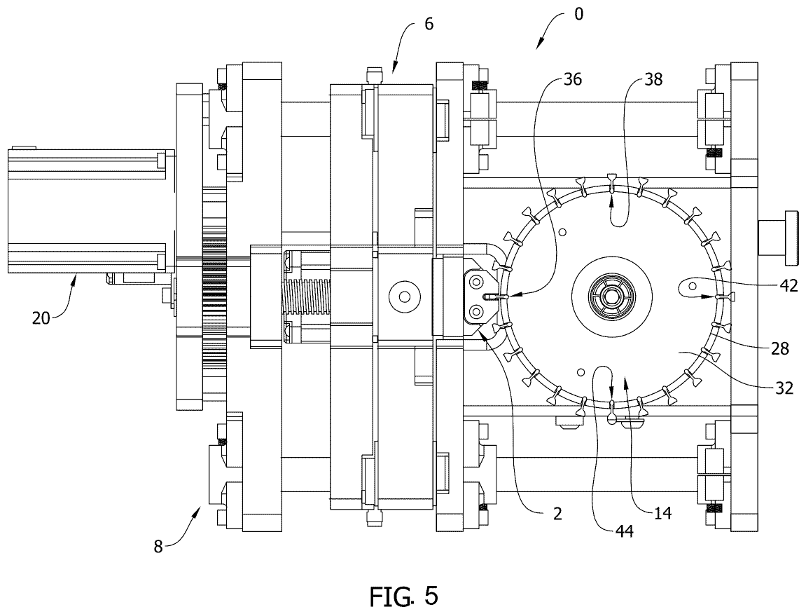

FIG. 6 is a representation of an elevation, cross section view of the apparatus.

FIG. 7 is a representation of a top plan view of a jaw actuator and specimen cartridge of the apparatus.

FIG. 8 is a representation of a perspective view of the jaw actuator and specimen cartridge of FIG. 7.

FIG. 9 is a representation of a perspective view of a camera assembly of the apparatus relative to the jaw actuator and specimen cartridge of the apparatus.

Corresponding reference numerals may indicate corresponding (though not necessarily identical) parts throughout the several views of the drawings.

### DETAILED DESCRIPTION

Example embodiments will now be described more fully with reference to the accompanying drawings.

In exemplary embodiments, a tensile testing apparatus is constructed to test a large number of material specimens in tension in a time efficient manner. The test specimens are each preformed in a same elongate configuration with enlarged gripping areas at opposite ends that enable each specimen to be acted on by the components of the apparatus to be described. The apparatus may be employed in testing a large number of specimens of one particular material, or a large number of specimens of various types of materials.

The apparatus is comprised of a base structure or base. The base structure supports a specimen holder or a specimen cartridge on the base structure. The base structure also supports a jaw actuator or actuator on the base structure. The base structure includes a control system that controls the operations of the specimen holder, the jaw actuator, cameras, and other operative features of the apparatus.

The specimen holder is a separate component part of the apparatus from the base structure. The specimen holder is removably attachable to the base structure. With the specimen holder removed from the base structure, the specimen holder is operable to receive and hold one or more test specimens on the specimen holder while the specimen holder is separate from the base structure.

The specimen holder is in the form of a specimen cartridge having a circular configuration with multiple slots formed in the cartridge. The multiple slots are spatially arranged in a circular pattern around a periphery of the cartridge. Each slot of the multiple slots has a configuration for receiving a portion of a test specimen in the slot and holding the specimen in the slot. A free end of each specimen projects from the slot and from the periphery of the specimen holder.

After the specimen holder or cartridge has been loaded with test specimens, the specimen holder is attached to the base structure. The specimen holder attached to the base is rotatable on the base. Rotation of the specimen holder on the base rotates the specimens in a circular pattern on the base.

The jaw actuator or actuator on the base is positioned adjacent the specimen holder when the specimen holder is removably attached to the base structure. The actuator is operable to grip a free end of a specimen held by the specimen holder after the specimen holder has been attached to the base and rotation of the specimen holder on the base structure has positioned the free end of the specimen relative to the actuator where the actuator is operable to grip the specimen held by the specimen holder.

The actuator has a first jaw member and a second jaw member. The first jaw member and the second jaw member are operable to engage and grip the free end of the specimen held by the specimen holder moved by rotation of the specimen holder to a position between the first jaw member and the second jaw member. The first jaw member and the second jaw member are operable to grip the free end of the specimen between the first jaw member and the second jaw member and then to pull the specimen in tension from the specimen holder until breakage of the specimen.

A camera is supported on the base structure. The camera is supported on the base structure with the camera directed toward the actuator gripping the free end of the specimen held by the specimen holder. The camera is operable to observe the specimen and record the specimen as the specimen is pulled in tension until breakage of the specimen. The camera is one camera, or a third camera of four cameras supported on the base structure.

A first camera supported on the base structure is operable to observe a specimen held by the specimen holder as an indicia applicator applies indicia to the specimen.

A second camera supported on the base structure is operable to observe and record a speckled pattern applied to a specimen held by the specimen holder by an indicia applicator.

A fourth camera supported on the base structure is operable to observe and record movements of the indicia on the specimen that has been pulled in tension by the actuator until breakage of the specimen.

The features, functions, and advantages of the tensile testing apparatus that have been disclosed herein can be achieved independently in various embodiments of the apparatus or may be combined in yet other embodiments, further details of which can be seen with reference to the following description and drawings.

With reference to the figures, the tensile testing apparatus 10 of this disclosure is basically comprised of a jaw actuator or an actuator 12 and a specimen holder or a specimen cartridge 14 that are mounted to a base structure or base 16 of the apparatus. The jaw actuator 12, the specimen cartridge 14 and the base structure 16 are constructed of materials that provide a structural soundness to the component parts of the apparatus 10 that is sufficient for the intended functioning of the apparatus.

The base structure 16 is constructed to support the specimen cartridge 14 relative to the jaw actuator 12. The base structure 16 also supports other operative features of the apparatus such as cameras which will be described. The specimen cartridge 14 or specimen holder is a separate component part of the apparatus that is removably attached to the base structure 16. The specimen holder 14 can be manually gripped and easily raised from and removed from the base structure 16 to load the specimen holder 14 with one or more test specimens of material to be tested. After the specimen holder 14 has been loaded with one or more specimens, the specimen holder 14 can be manually moved downward onto and attached to the base structure 14. In the exemplary embodiment, the specimen holder 14 is constructed with a center shaft that can be inserted into a tubular receiver of the base 16. The control system 18 of the base 16 controls rotation of the receiver and thereby rotates the specimen holder 14. The center shaft can be manually inserted into the receiver and manually pulled out of the receiver without the use of tools. This enables the specimen holder 14 to be easily removed from the base16, the spent or used specimens can be removed from the specimen holder 14, the specimen holder 14 can then be reloaded with additional specimens to be tested and the reloaded specimen holder 14 attached to the base 16 by insertion of the shaft of the specimen holder 14 into the receiver of the base 16. This quick change of the specimen holder 14 with the base 16 enables time efficient testing of a large number of specimens. The base structure also supports one or more motive devices 20 of the apparatus that control the operations of the jaw actuator and the specimen cartridge to be described. The control system 18 of the base structure 16 is operable to control the motive devices 20 to move the specimen cartridge 14 and jaw actuator 12 horizontally toward and away from each other. The control system 18 of the base structure 16 is also operable to control rotation the specimen cartridge 14 on the base structure 16.

Rotation of the specimen cartridge 14 on the base structure 16 is controlled by the control system 18 of the base structure 16 to rotate the specimen cartridge 14 in indexed, increments of rotation or segments of rotation. The segments of rotation are equal to the number of material specimens supported by the specimen cartridge 14, and the lengths of the segments of rotation are equal to the distance between adjacent specimens supported on the specimen cartridge 14. The segmented rotation of the specimen cartridge 14 controlled by the control system 18 presents one material specimen at a time to the jaw actuator 12. The controlled rotation of the specimen cartridge 14 presents a specimen positioned relative to or opposite the opened jaw actuator 12. The jaw actuator 12 is then controlled to move toward the presented specimen and grip the specimen. The jaw actuator 12 and the specimen cartridge 14 are then controlled to conduct a tensile test of the one material specimen presented to the jaw actuator 12 by the controlled movement of the jaw actuator 12 away from the specimen cartridge 14. The tensile test could be conducted to stretch the specimen to a certain degree, or to stretch the specimen to breakage. When the tensile test is completed, the jaw actuator 12 is controlled by the control system 18 to release the tested material specimen or the remnant of the specimen and the specimen cartridge 14 is controlled by the control system 18 to rotate in one segment of rotation to present a next, subsequent material specimen to the jaw actuator 12 for testing.

As set forth earlier, the base structure 16 supports the specimen cartridge 14 with the specimen cartridge 14 being removably attached to the base structure 16. A specimen cartridge attached to the base structure 16 has been loaded with a plurality of material specimens desired to be tested by the apparatus 10. The specimen cartridge 14 attached to the base structure 16 can be removed when the material specimens held by the specimen cartridge 14 have been used or completed their testing. The removed specimen cartridge 14 can have the tested material specimens removed from the cartridge and replaced with a new, plurality of material specimens to be tested by the apparatus 10. The specimen cartridge 14 can be removed from the base structure 16 and the used or tested specimens can then be removed from the specimen cartridge 14. The removed cartridge 14 can be reloaded with new specimens at a separate location from the apparatus 10. The specimen cartridge 14 being removable from the base structure 16 also enables a first, used specimen cartridge 14 to be removed from the base structure 16 and the immediate attachment of a second, preloaded specimen cartridge 14 to the base structure 16 to replace the first, used specimen cartridge removed. This significantly improves time efficiency in testing specimens. The specimen cartridge 14 being removable from the base structure 16 also enables several specimen cartridges 14 to be preloaded with test specimens for immediate replacement of a used specimen cartridge 14. This also improves time efficiency in testing specimens.

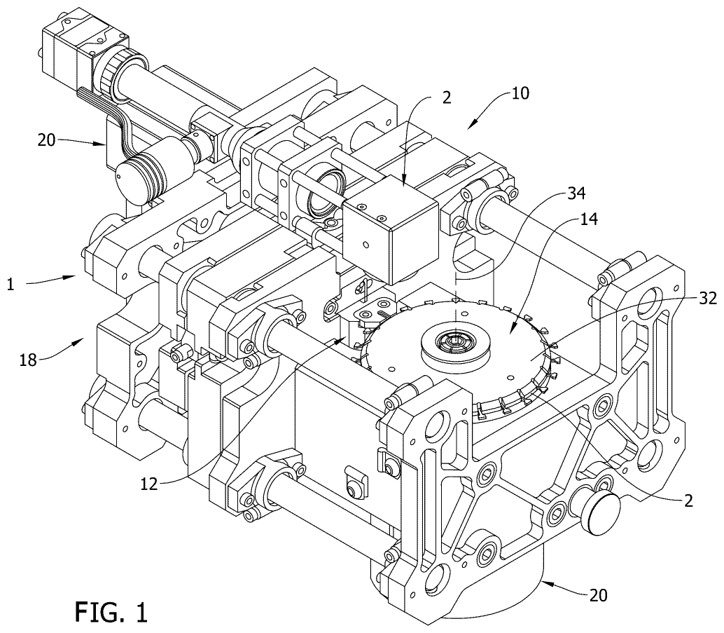

As represented in FIG. 1, the jaw actuator 12 is positioned adjacent the specimen cartridge 14 on the base structure 16. The jaw actuator 12 is controlled by the control system 18 of the base structure 16 to move horizontally toward and away from the specimen cartridge 14, and/or to move vertically downward toward the top of the specimen cartridge 14 and vertically upward away from the top of the specimen cartridge 14. The jaw actuator 12 could also be controlled to move vertically downward away from the bottom of the specimen cartridge 14 and vertically upward toward the bottom of the specimen cartridge 14.

The jaw actuator 12 is comprised of a first jaw member 22 and a second jaw member 24. The control system 18 of the base structure 16 controls the operation of the jaw actuator 12 to move the first jaw member 22 and the second jaw member 24 together relative to the base structure 16 and the specimen cartridge 14. The first jaw member 22 and second jaw member 24 are position horizontally opposite each other on the jaw actuator 12 with a horizontal spacing 26 between the first jaw member 22 and the second jaw member 24. The horizontal spacing between the first jaw member 22 and the second jaw member 24 is dimensioned to receive a free end of a specimen moved by the specimen cartridge 14 to a position adjacent the spacing 26 between the first jaw member 22 and the second jaw member 24. In other embodiments of the apparatus 10, the first jaw member 22 and the second jaw member 24 could be positioned on the actuator 12 spaced vertically opposite each other with a vertical space between the first jaw member and the second jaw member dimensioned to receive a free end of a specimen in the vertical space.

In the exemplary embodiment, the jaw actuator 12 is operable to move the first jaw member 22 and the second jaw member 24 together, horizontally away from the specimen cartridge 14 by a small distance. This provides clearance for the specimen cartridge 14. As a specimen cartridge 14 is attached to the base structure 16, the jaw actuator 12 and the first 22 and second 24 jaw members have been moved together, horizontally to a position adjacent the area of the base structure 16 where the specimen cartridge 14 is attached to the base structure 16. This positioning of the jaw actuator 12 provides ample clearance and access for the specimen cartridge 14 to be attached to the base structure 16. The jaw actuator 12 is then controlled to move the first jaw member 22 and the second jaw member 24 horizontally apart, creating a horizontal spacing 26 between the first jaw member 22 and the second jaw member 24. The specimen cartridge 14 holds a specimen adjacent the actuator jaw 12 with the specimen projecting from the periphery of the specimen cartridge 14 to a free end of the specimen. The free end of the specimen is held by the specimen cartridge 14 at a position directly adjacent the horizontal space between the first jaw member 22 and the second jaw member 24. The jaw actuator 12 is then operated by the control system 18 of the base structure 16 to move horizontally toward the specimen cartridge 14 until the first jaw member 22 and the second jaw member 24 are positioned on opposite sides of the free end of the specimen positioned or presented at the jaw actuator 12 by the specimen cartridge 14. The jaw actuator 12 is operable to selectively move the first jaw member 22 and the second jaw member 24 together, closing the horizontal spacing 26 between the first jaw member and the second jaw member and gripping the free end of the specimen between the jaw members. The jaw actuator 12 could be controlled to move the first jaw member 22 towards the second jaw member 24 while the second jaw member 24 remains stationary. Alternatively, operation of the jaw actuator 12 could move the second jaw member 24 toward the first jaw member 22 while the first jaw member remains stationary. Still further, the jaw actuator 12 could be operable to move the first jaw member 22 and the second jaw member 24 together simultaneously. Alternatively, the first jaw member 22 could be positioned above the second jaw member 24 with a vertical spacing between the first jaw member and the second jaw member. The jaw actuator 12 would then be operable to selectively move the first jaw member 22 and the second jaw member 24 together, closing the vertical spacing between the first jaw member and the second jaw member and gripping the free end of the specimen between the jaw members.

The jaw actuator 12 is operable to selectively move the first jaw member 22 and the second jaw member 24 together, horizontally toward and away from the specimen cartridge 14. The jaw actuator 12 is operable to selectively move the first jaw member 22 and the second jaw member 24 together between first positions of the jaw members where the jaw members are positioned on opposite sides of a free end of a specimen held by the specimen cartridge 14, to second positions of the jaw members where the jaw members that have gripped the free end of the specimen are moved away from the specimen cartridge to pull the gripped specimen and apply a tensile test to the gripped specimen.

The specimen cartridge or cartridge 14 has a cylindrical configuration defined by a cylindrical peripheral surface or wall 28 of the cartridge 14. The cartridge 14 also has a circular top surface 32 defined by the cylindrical configuration of the peripheral surface 28 of the cartridge. The cartridge 14 is rotatable on the base 16 around a center axis 34 of the cartridge 14 relative to the base and relative to the jaw actuator 12. As stated earlier, the cartridge 14 is controlled by the control system 18 of the base structure 16 or is operable to rotate in segments of rotation relative to the jaw actuator 12. The cartridge 14 is operable to rotate in indexed or segment movements between a number of segments of rotation that equal the number of specimens held by the cartridge 14.

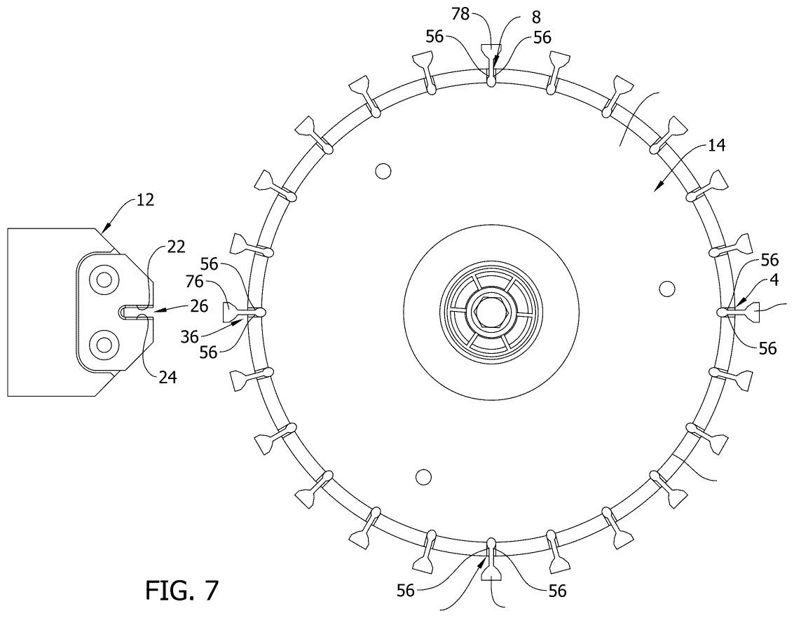

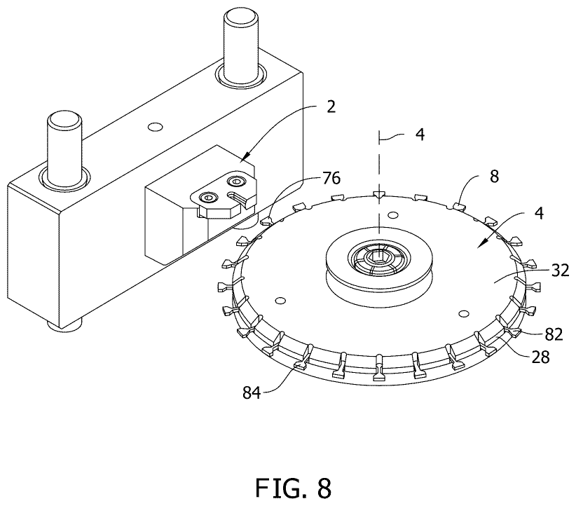

A plurality of slots are provided in the cartridge 14. As represented in FIGS. 7-9, the plurality of slots includes twenty-four equally spaced slots around the peripheral surface 28 of the cartridge 14. Only four slots 36, 38, 42, 44 of the twenty-four slots are labelled in the drawing figures. In other embodiments of the cartridge 14, there could be more than twenty-four slots or fewer than twenty-four slots. The slots are spatially positioned around the peripheral wall 28 of the cartridge 14. There are equal spacings between the slots. Each slot passes through the top surface 32 of the cartridge 14 and through a portion of the peripheral wall 28 of a cartridge. Each slot is accessible through the top surface 32 of the cartridge 14 and is configured for receiving a first end of a specimen where the specimen has a length between a first end of the specimen and a second end or free end of the specimen. Each slot is configured to receive the first end of the specimen through the slot in the top surface 32 of the cartridge 14. Each slot is also configured to enable the specimen to be positioned in the slot with the first end of the specimen in the slot and the length of the specimen extending through and from the peripheral wall 28 of the cartridge 14 to the second end or free end of the specimen positioned outside the slot.

As represented in FIG. 7, specimen engagement devices 56 are positioned in each of the slots 36, 38, 42, 44 and inside the specimen cartridge 14. The specimen engagement devices 56 function as grippers or graspers that are operable to grip and hold the first end of a specimen positioned in the slots 36, 38, 42, 44. The specimen engagement devices 56 could be mechanical devices that are operated by the control system 18 of the base structure 16 to move and engage the specimens. The specimen engagement devices could be stationary structures having complementary shapes to the shapes of the first ends of the specimens to receive the first ends of the specimens inserted into the structures and hold the first ends against movement from the structures. The specimen engagement devices 56 are also operable to release the first end of the specimen gripped by the specimen engagement device 56 inside the slot after the specimen has been tested.

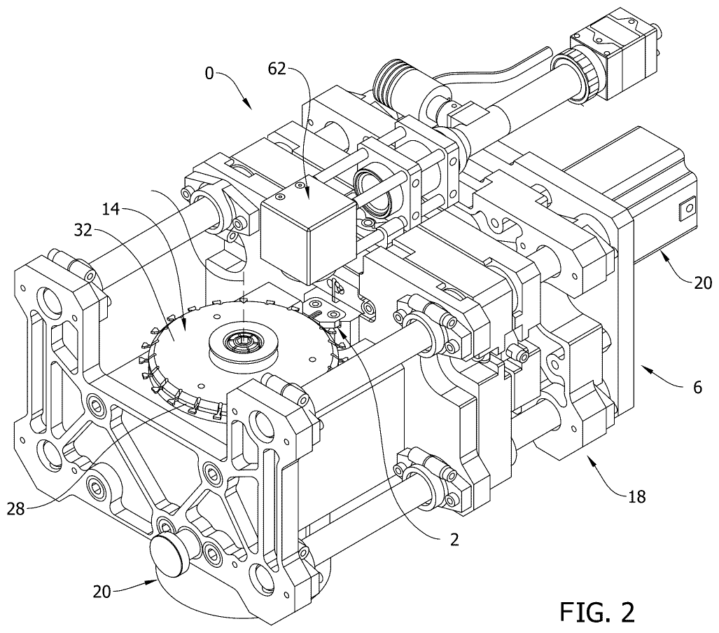

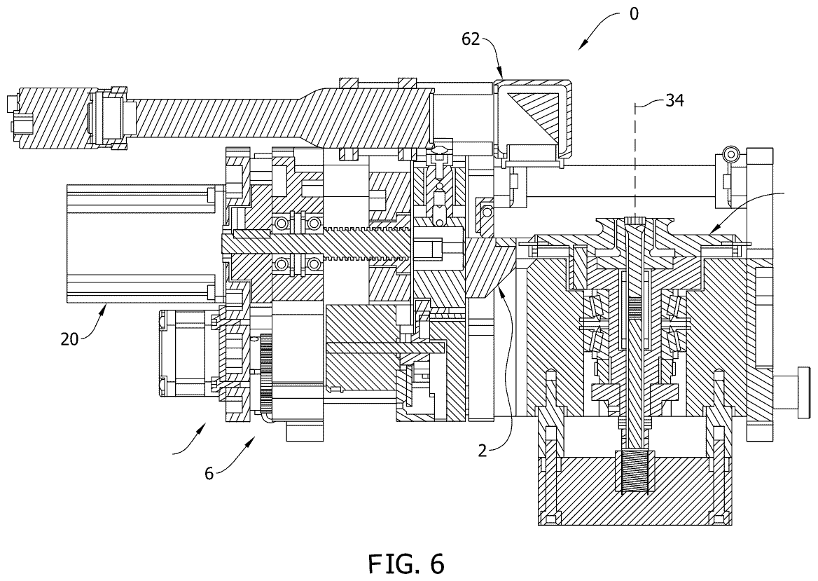

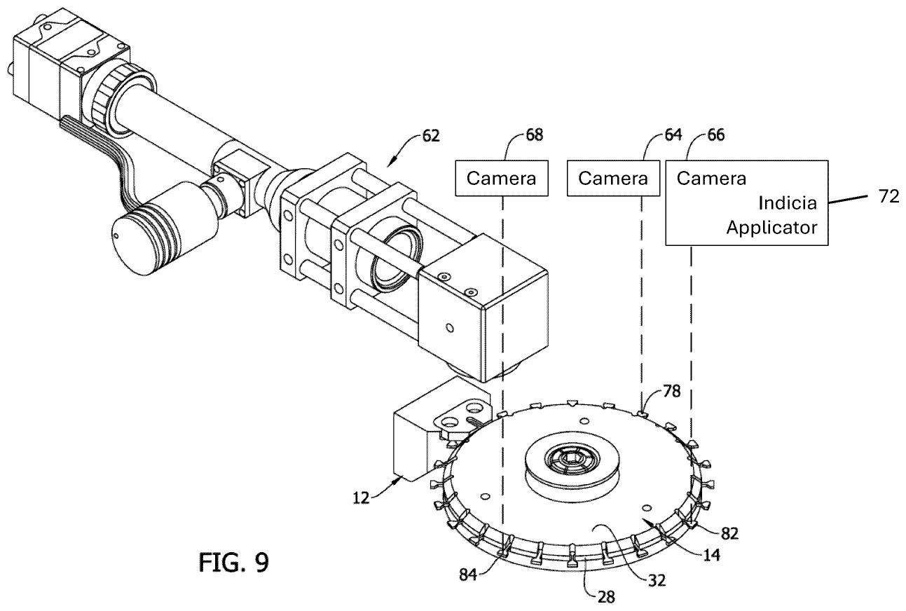

The tensile testing apparatus 10 is also comprised of four camera assemblies 62, 64, 66, 68. The operation of the cameras is controlled by the control system 18 of the apparatus. Only one of the camera assemblies 62 is represented on the apparatus 10 in FIGS. 1, 2 and 6. The first camera assembly 62 is represented positioned relative to the jaw actuator 12 and cartridge 14, and above the first slot 36 in FIG. 9. The lens of the camera assembly 62 is directed downward toward the specimen held by the specimen engaging devices 56 of the cartridge 14 and toward the first 22 and second 24 jaw members. The second 64, third 66 and fourth 68 camera assemblies are represented schematically by rectangles in FIG. 9. The apparatus 10 could include more than four camera assemblies, or fewer than four camera assemblies. The apparatus could comprise a camera positioned stationary above each of the positions of the slots in the specimen cartridge 14. As represented in FIG. 9, the four cameras 62, 64, 66, 68 are positioned stationary above the respective four slots 36, 38, 42, 44. Each of the cameras 62, 64, 66, 68 is a high precision camera such as a digital image correlation camera or an equivalent type of camera device that is capable of viewing or sensing minute details of a specimen held in each slot 36, 38, 42, 44 of the specimen cartridge 14.

At the location of the first camera 62, there could be additional cameras to the one camera 62 shown. For example, there could be multiple cameras supported on the base structure 16 at positions around the jaw actuator 12. The cameras could provide a view from above the specimen in the jaw actuator 12, in addition to views of the specimen from around the specimen to monitor the specimen from various angles as the specimen is tested.

In operation of the apparatus 10 represented in FIGS. 7-9, in this example four specimens 76, 78, 82, 84 of a material to be tested or of different materials to be tested are loaded into each of the slots 36, 38, 42, 44, respectively. In actual use of the apparatus, all the slots of the cartridge 14 would be filled with specimens. The specimens 76, 78, 82, 84 are positioned in the slots with the first ends of the specimens positioned in the slots and gripped by the specimen engagement devices 56, and with the lengths of the specimens extending from the slots outside the peripheral surface 28 of the cartridge 14. As represented in FIGS. 7, 8 and 9, the first specimen 76 is positioned in the first slot 36, the second specimen 78 is positioned in the second slot 38, the third specimen 82 is positioned in the third slot 42 and the fourth specimen 84 is positioned in the fourth slot 44.

The tensile testing apparatus 10 also includes an indicia marker or applicator device 72 represented schematically by a rectangle in FIG. 9. As represented in FIG. 9, the indicia applicator device 72 is positioned adjacent the third camera 66 and above the third slot 42. The indicia applicator 72 is positioned stationary directly above the third slot 42 where the applicator 72 is operable to apply indicia in a speckled pattern, or other equivalent position indicating markings to a specimen 82 held in the third slot 42. The indicia are applied to the specimen 82 by the applicator 72 primarily along the length of the specimen that extends from the third slot 42 and from the peripheral wall 26 of the specimen cartridge 14. The indicia could be applied along the entire length of the specimen. The third camera 66 observes and records the application of the indicia. The indicia applied to the length of the specimen 82 by the indicia applicator 72 is used to observe the stretching and relative movements of portions of the specimen length during the testing of the specimen, and observe stretching and other deformations of the specimen length that have occurred during and after the testing of the specimen.

The indicia applicator 72 is operated to apply indicia in a speckled pattern to the third specimen 82 in the third slot 42. The indicia applicator 72 is operable to apply the indicia into the third slot 42 and on the first end of the third specimen 82, along the length of the third specimen 82 to the second end of the third specimen 82. The third camera 66 positioned above the third slot 42 monitors the application of the indicia to the third specimen 82.

The fourth camera 68 observes the fourth specimen 84 in the fourth slot 44 that has previously had its indicia markings applied to the specimen. The fourth camera 68 records the pattern of the indicia applied to the fourth specimen 84 and the relative positions of portions of the pattern.

The first camera 62 is positioned above the first slot 36 and the first specimen 76 in the first slot 36. The first camera 62 observes the first specimen 76 as the second end or free end of the specimen is gripped by the first jaw member 22 and second jaw member 24 of the jaw actuator 12, and as the first specimen 76 is subjected to tensile force produced by the jaw actuator 12. The first camera 62 records the first specimen 76 as the specimen is tested by being stretched by the jaw actuator 12. The specimen 76 could be tested until breakage of the specimen. The first camera 62 records the relative movements of the indicia applied to the first specimen 76 as the first specimen is subjected to tensile force by the jaw actuator 12 and stretched, or stretched and until the breakage of the first specimen.

The second camera 64 observes and records the image of the second specimen 78 after the specimen has been stretched, or stretched and broken. The second camera 64 observes the positions of the speckled pattern on the second specimen 78 and together with the fourth camera 68 produces a pattern of movements of the speckled pattern on the second specimen 78 resulting from the specimen being stretched by the jaw actuator 12 until breakage of the specimen. The second slot 38 holding the second specimen 78 can dispense the broken first end of the specimen from the slot making the slot available for the loading of a further specimen in the slot.

In place of or in addition to the cameras and the other devices supported on the base structure 16 and positioned around the specimen cartridge 14 described above, there could be other various different types of testing devices supported by the base structure 16. For example, various different types of laser testing devices such as laser displacement sensors or other geometry measurement sensors that detect changes in the surface of the specimen as the specimen is tested could be supported by the base structure 16 at positions around the specimen cartridge 14. More than one sensor and more than one type of sensor, for example a combination of a camera and a geometry sensor could be positioned at locations around the specimen cartridge 14.

The tensile testing apparatus 10 described above is an autonomous miniature tensile testing apparatus that provides clear views of the specimens by cameras as the specimens are moved through four stages of testing. The apparatus 10 enables simultaneous movement of the four specimens to the jaw actuator 12 and then from the jaw actuator. As the specimen cartridge 14 rotates and moves specimens in a horizontal plane to the jaw members 22, 24 of the jaw actuator 12, the specimens are observed by the cameras 62, 64, 66, 68 without obstruction in the four slots 36, 38, 42, 44.

In some exemplary embodiments, the tensile testing apparatus comprises a modular cartridge system that includes a plurality of interchangeable specimen cartridges. Each of the interchangeable specimen cartridges configured to hold multiple specimens of different specimen types. A mechanism enable removal and replacement of the interchangeable cartridges. A camera/reader sensing and drive control system is operable to identify specimen cartridge type and adjust testing parameters accordingly to the identified specimen cartridge type. The mechanism may comprise a quick-release mechanism enabling manual removal and replacement of the interchangeable cartridges without tools. The specimen cartridges may include one or more labels, markings, engravings, and/or other identifying indicia on the specimen cartridges that are both human and machine readable and that identify the different types of specimens to be used with the interchangeable specimen cartridges.

In some exemplary embodiments, a point laser displacement sensor is adjacent the specimen holder for detecting surface changes of each specimen during tensile testing; and/or a line laser displacement sensor is adjacent the specimen holder for detecting geometric profile changes of each specimen during tensile testing.

In some exemplary embodiments, multiple cameras, laser displacement sensors, and/or geometry measurement sensors are synchronized to capture multi-angle views of a specimen during tensile testing and generate a composite deformation profile for failure analysis of multi-material systems such as: two materials bonded together and tensile tested in-line and/or parallel to the bond;
composite materials including multiple materials distributed volumetrically throughout the specimen; and/or other heterogeneous material systems that exhibit unique failure behavior.

Also disclosed are exemplary methods for autonomously testing a plurality of specimens in tension. An exemplary method comprises loading a plurality of specimens into a rotatable specimen cartridge, each specimen having a free end extending from the cartridge; rotating the specimen cartridge to sequentially position each specimen adjacent a jaw actuator; gripping the free end of each specimen with the jaw actuator; applying a tensile force to each specimen until deformation or breakage occurs; and recording the deformation of each specimen using at least one camera and/or other sensor positioned adjacent the jaw actuator. The method may also comprise detecting surface changes of each specimen during tensile testing using a point laser displacement sensor adjacent the specimen cartridge; and/or detecting geometric profile changes of each specimen during tensile testing using a line laser displacement sensor adjacent the specimen cartridge. The method may further comprise loading the plurality of specimens into the specimen cartridge when the specimen cartridge is removed and separated from a base structure; attaching the specimen cartridge loaded to the base structure; and rotating the specimen cartridge relative to the base structure to thereby sequentially position each specimen adjacent the jaw actuator. The method may additionally comprise capturing multi-angle views of a specimen during tensile testing using multiple cameras, laser displacement sensors, and/or geometry measurement sensors; and generating a composite deformation profile for failure analysis of multi-material systems such as: two materials bonded together and tensile tested in-line and/or parallel to the bond; composite materials including multiple materials distributed volumetrically throughout the specimen; and/or other heterogeneous material systems that exhibit unique failure behavior.

Also disclosed are exemplary embodiments of a specimen cartridge for use in a tensile testing apparatus. The specimen cartridge comprises a circular body having multiple slots spatially arranged in a circular pattern around a periphery of the circular body. Each slot is configured to receive and retain a specimen such that a free end of the specimen projects outward from the circular body. The specimen cartridge includes a central shaft configured for removable engagement with a base structure of the tensile testing apparatus, such that the specimen cartridge is rotatable relative to the base structure for sequentially presenting the multiple specimens held in the multiple slots to an actuator of the tensile testing apparatus. The multiple slots may be arranged equidistant slots around the periphery of the circular body. The specimen cartridge may comprise specimen engagement devices within each slot operable to selectively grip and release the specimen ends. The specimen cartridge may include one or more labels, markings, engravings, and/or other identifying indicia on the specimen cartridge that are both human and machine readable and that identify the type of specimen to be used with the specimen cartridge.

Exemplary embodiments of a modular cartridge system for a tensile testing apparatus are also disclosed. In exemplary embodiments, the modular cartridge system comprises a plurality of interchangeable specimen cartridges. Each of the interchangeable specimen cartridges configured to hold multiple specimens of different specimen types. A mechanism enables removal and replacement of the interchangeable cartridges. And a camera/reader sensing and drive control system is operable to identify specimen cartridge type and adjust testing parameters accordingly to the identified specimen cartridge type. The mechanism may comprise a quick-release mechanism enabling manual removal and replacement of the interchangeable cartridges without tools. Each specimen cartridge may include one or more labels, markings, engravings, and/or other identifying indicia on the specimen cartridge that are both human and machine readable and that identify the different types of specimen to be used with the interchangeable specimen cartridges.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. For example, when permissive phrases, such as “may comprise”, “may include”, and the like, are used herein, at least one embodiment comprises or includes the feature(s). As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,”“adjacent” versus “directly adjacent,”etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tensile testing apparatus comprising:
a base structure;
a specimen holder removably attachable to and rotatable relative to the base structure, the specimen holder configured to hold multiple specimens on the specimen holder, wherein the specimen holder is removable and separatable from the base structure such that the specimen holder can be loaded independently with the multiple specimens and then attached to the base structure; and
an actuator on the base structure, the actuator being operable to grip a corresponding specimen of the multiple specimens held by the specimen holder after the specimen holder has been attached to the base structure.

2. The tensile testing apparatus of claim 1, wherein the tensile testing apparatus is configured such that the multiple specimens held by the specimen holder are simultaneously moved through different stages of testing when the specimen holder is attached to and rotated relative to the base structure.

3. The tensile testing apparatus of claim 1, wherein:
the specimen holder is configured to hold the multiple specimens on the specimen holder when the specimen holder is removed from the base structure and is separated from the base structure; and
the specimen holder is configured to hold the multiple specimens on the specimen holder as the specimen holder is attached to the base structure and after the specimen holder has been attached to the base structure.

4. The tensile testing apparatus of claim 1, wherein:
the base structure is operable to rotatingly move the specimen holder attached to the base structure in indexed or segment movements to thereby move the corresponding specimen held by the specimen holder toward the actuator and position the corresponding specimen held by the specimen holder adjacent the actuator with the actuator being operable to grip the corresponding specimen held by the specimen holder; and
the actuator is movable away from the specimen holder to pull the corresponding specimen held by the specimen holder and apply a tensile test to the specimen.

5. The tensile testing apparatus of claim 1, wherein:
the tensile testing apparatus comprises multiple cameras supported on the base structure and positioned around the specimen holder for different simultaneous stages of the tensile testing including indicia application, pattern recording, tension observation, and post-failure analysis; and
corresponding specimens of the multiple specimens held by the specimen holder are observable by the multiple cameras without obstruction as the multiple specimens are simultaneously moved through different simultaneous stages of testing when the specimen holder is attached to and rotated relative to the base structure in indexed or segment movements.

6. The tensile testing apparatus of claim 1, wherein:
the tensile testing apparatus comprises a specimen engagement device on the specimen holder, the specimen engagement device being operable to engage a specimen and hold the specimen on the specimen holder with a free end of the specimen projecting from the specimen holder; and
the actuator is operable to grip the free end of the specimen projecting from the specimen holder and move away from the specimen holder to thereby pull the gripped specimen and apply a tensile test to the gripped specimen.

7. The tensile testing apparatus of claim 1, wherein:
the specimen holder comprises a specimen cartridge having a circular configuration with multiple slots in the specimen cartridge;
the multiple slots are spatially arranged in a circular pattern around a periphery of the specimen cartridge;
each slot of the multiple slots has a configuration for receiving and holding a specimen in the slot such that a free end of the specimen projects from the specimen cartridge; and
the specimen cartridge is rotatable for sequentially presenting the multiple specimens held in the multiple slots to the actuator.

8. The tensile testing apparatus of claim 1, wherein:
the actuator comprises a jaw actuator on the base structure and positioned adjacent the specimen holder when the specimen holder is removably attached to the base structure;
the jaw actuator includes first and second jaw members operable to:
grip the corresponding specimen of the multiple specimens held by the specimen holder that has been moved by rotation of the specimen holder into a position adjacent the first and second jaw members; and
pull the corresponding specimen in tension.

9. The tensile testing apparatus of claim 1, wherein:
the tensile testing apparatus further comprises one or more cameras, laser displacement sensors, and/or geometry measurement sensors supported on the base structure and positioned around the specimen holder for different simultaneous stages of the tensile testing of the multiple specimens including indicia application, pattern recording, tension observation, and post-failure analysis;
the multiple specimens are observable by the one or more cameras, laser displacement sensors, and/or geometry measurement sensors as the multiple specimens are simultaneously moved through the different simultaneous stages of tensile testing when the specimen holder is rotated relative to the base structure in indexed or segment movements; and
the one or more cameras, laser displacement sensors, and/or geometry measurement sensors are operable for observing and recording deformation and reaction of the multiple specimens to the tensile testing.

10. The tensile testing apparatus of claim 1, wherein the tensile testing apparatus further comprises multiple laser displacement sensors supported on the base structure and positioned around the specimen holder to measure specimen dimensions before testing and fracture surface cross sectional area after testing.

11. The tensile testing apparatus of claim 1, further comprising:
a first camera adjacent the specimen holder and configured to be operable to observe a specimen as an indicia applicator applies indicia to the specimen;
a second camera adjacent the specimen holder and configured to be operable to observe and record a speckled pattern applied to a specimen by the indicia applicator;
a third camera adjacent the specimen holder and configured to be operable to observe and record a specimen as the specimen is pulled in tension by the actuator; and
a fourth camera adjacent the specimen holder and configured to be operable to observe and record movements of indicia on a specimen that has been pulled in tension by the actuator.

12. The tensile testing apparatus of claim 1, wherein the specimen holder comprises a first specimen cartridge, and wherein the tensile testing apparatus comprises a modular cartridge system that includes:
a plurality of interchangeable specimen cartridges including the first specimen cartridge, each of the interchangeable specimen cartridges configured to hold multiple specimens of different specimen types;
a mechanism enabling removal and replacement of the interchangeable cartridges; and
a camera/reader sensing and drive control system operable to identify specimen cartridge type and adjust testing parameters accordingly to the identified specimen cartridge type.

13. The tensile testing apparatus of claim 12, wherein the mechanism comprises a quick-release mechanism enabling manual removal and replacement of the interchangeable cartridges without tools.

14. The tensile testing apparatus of claim 1, wherein the specimen holder includes one or more labels, markings, engravings, and/or other identifying indicia on the specimen holder that are both human and machine readable and that identify the type of specimen to be used with the specimen holder.

15. The tensile testing apparatus of claim 1, wherein the tensile testing apparatus comprises:
a point laser displacement sensor adjacent the specimen holder for detecting surface changes of each specimen during tensile testing; and/or
a line laser displacement sensor adjacent the specimen holder for detecting geometric profile changes of each specimen during tensile testing.

16. The tensile testing apparatus of claim 1, wherein the tensile testing apparatus further comprises multiple cameras, laser displacement sensors, and/or geometry measurement sensors synchronized to capture multi-angle views of a specimen during tensile testing and generate a composite deformation profile for failure analysis of multi-material systems such as:
two materials bonded together and tensile tested inline and/or parallel to the bond;
composite materials including multiple materials distributed volumetrically throughout the specimen; and/or
other heterogeneous material systems that exhibit unique failure behavior.

17. A method for autonomously testing a plurality of specimens in tension, the method comprising:
loading a plurality of specimens into a rotatable specimen cartridge, each specimen having a free end extending from the cartridge;
rotating the specimen cartridge to sequentially position each specimen adjacent a jaw actuator;
gripping the free end of each specimen with the jaw actuator;
applying a tensile force to each specimen until deformation or breakage occurs; and
recording the deformation of each specimen using at least one camera and/or other sensor positioned adjacent the jaw actuator.

18. The method of claim 17, further comprising:
detecting surface changes of each specimen during tensile testing using a point laser displacement sensor adjacent the specimen cartridge; and/or
detecting geometric profile changes of each specimen during tensile testing using a line laser displacement sensor adjacent the specimen cartridge.

19. The method of claim 17, wherein the method includes:
loading the plurality of specimens into the specimen cartridge when the specimen cartridge is removed and separated from a base structure;
attaching the specimen cartridge loaded to the base structure; and
rotating the specimen cartridge relative to the base structure to thereby sequentially position each specimen adjacent the jaw actuator.

20. The method of claim 17, wherein the method includes:
capturing multi-angle views of a specimen during tensile testing using multiple cameras, laser displacement sensors, and/or geometry measurement sensors; and
generating a composite deformation profile for failure analysis of multi-material systems such as:
two materials bonded together and tensile tested in-line and/or parallel to the bond;
composite materials including multiple materials distributed volumetrically throughout the specimen; and/or
other heterogeneous material systems that exhibit unique failure behavior.

21. A specimen cartridge for use in a tensile testing apparatus, the specimen cartridge comprising:
a circular body having multiple slots spatially arranged in a circular pattern around a periphery of the circular body, each slot configured to receive and retain a specimen such that a free end of the specimen projects outward from the circular body; and
a central shaft configured for removable engagement with a base structure of the tensile testing apparatus, such that the specimen cartridge is rotatable relative to the base structure for sequentially presenting the multiple specimens held in the multiple slots to an actuator of the tensile testing apparatus.

22. The specimen cartridge of claim 21, wherein:
the multiple slots are arranged equidistant slots around the periphery of the circular body; and/or
the specimen cartridge comprises specimen engagement devices within each slot operable to selectively grip and release the specimen ends; and/or
the specimen cartridge includes one or more labels, markings, engravings, and/or other identifying indicia on the specimen cartridge that are both human and machine readable and that identify the type of specimen to be used with the specimen cartridge.

23. A modular cartridge system for a tensile testing apparatus, the modular cartridge system comprising:
a plurality of interchangeable specimen cartridges including the first specimen cartridge, each of the interchangeable specimen cartridges configured to hold multiple specimens of different specimen types;
a mechanism enabling removal and replacement of the interchangeable cartridges; and
a camera/reader sensing and drive control system operable to identify specimen cartridge type and adjust testing parameters accordingly to the identified specimen cartridge type.

24. The modular cartridge system of claim 23, wherein:
the mechanism comprises a quick-release mechanism enabling manual removal and replacement of the interchangeable cartridges without tools; and/or
each specimen cartridge includes one or more labels, markings, engravings, and/or other identifying indicia on the specimen cartridge that are both human and machine readable and that identify the type of specimen to be used with the specimen cartridge.
